(19) United States
(12) Patent Application Publication
(10) Pub. No.: US 2025/0301247 A1
(43) Pub. Date: Sep. 25, 2025

(54) ADJUSTABLE SPEAKER SYSTEM

(71) Applicant: Universal City Studios LLC, Universal City, CA (US)

(72) Inventors: Eric Ross Boxer, Clermont, FL (US); Michael James Gebhardt, Winter Garden, FL (US); Breanne D’Costa, Orlando, FL (US); Ryan Strembicki, Orlando, FL (US)

(21) Appl. No.: 19/083,196

(22) Filed: Mar. 18, 2025

Related U.S. Application Data
(60) Provisional application No. 63/566,992, filed on Mar. 19, 2024.

(51) Int. Cl. H04R 1/02; H04R 1/28

(52) U.S. Cl. CPC H04R 1/025; H04R 1/023; H04R 1/026; H04R 1/2803; H04R 2201/025

(57) ABSTRACT

A speaker system for an entertainment venue includes a speaker, a primary speaker housing configured to enclose the speaker, and one or more of supplemental housing modules. A first supplemental housing module is configured to detachably couple to the primary speaker housing, and is configured to define a first portion of a sound cavity for the speaker system, and a second supplemental housing module is configured to detachably couple to the first supplemental housing module, and is configured to define a second portion of the sound cavity of the speaker system.

### CROSS-REFERENCE TO RELATED APPLICATION

This application claims priority from and the benefit of U.S. Provisional Application Ser. No. 63/566,992, entitled “ADJUSTABLE SPEAKER SYSTEM”, filed Mar. 19, 2024, which is hereby incorporated by reference in its entirety.

### BACKGROUND

The present disclosure generally relates to speaker systems. Many entertainment venues use speakers to provide audio to attendees. For example, within an entertainment venue, embedded speakers may play various audio tracks (e.g., sound effects and/or songs) throughout a show and/or ride. The audio tracks may work synergistically with other elements of the show and/or ride to help captivate an audience. The speakers may be fixed within a structure that defines the entertainment venue or may be otherwise generally permanent installations within the entertainment venue (e.g., to provide audio to multiple attendees over time, such as over several years). In other areas of the entertainment venues, the speakers may be coupled to nonstationary objects (e.g., robots, animated figures) to provide audio to accompany movement and visual effects of the nonstationary objects. It is now recognized that it can be costly and time consuming to modify the speakers while fixed in a location of an entertainment venue and/or on a non-stationary object.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements art to be read in this light, and not as admissions of prior art.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In an embodiment, a speaker system for an entertainment venue includes a speaker with a primary speaker housing that is configured to at least partially enclose the speaker. The speaker system also includes one or more supplemental housing modules, where a first supplemental housing module of the one or more supplemental housing modules is configured to detachably couple to the primary speaker housing. The first supplemental housing module is also configured to define a first portion of a sound cavity for the speaker system. Further, the speaker system includes a second supplemental housing module of the one or more supplemental housing modules that is configured to detachably couple to the first supplemental housing module, and is also configured to define a second portion of the sound cavity of the speaker system.

In an embodiment, a speaker enclosure includes a primary speaker housing that is configured to nest about a speaker. The speaker enclosure also includes a first supplemental housing module that is configured to detachably couple to the primary speaker housing. The first supplemental housing module is also configured to define a portion of a sound cavity for the speaker enclosure having an axis. Further, the speaker enclosure includes a second supplemental housing module that is configured to detachably couple to the first supplemental housing module. The second supplemental housing module is also configured to define a second portion of the sound cavity of the speaker enclosure.

In an embodiment, a method of modifying a speaker system includes inserting a speaker into a primary speaker housing that is configured to at least partially enclose the speaker where the primary speaker housing comprises a first plurality of recesses and a plurality of locking channels. The method further includes detachably coupling one or more supplemental housing modules to the primary speaker housing until a desired sound is reached. The steps of detachably coupling include inserting a plurality of protrusions of a first supplemental housing module of the one or more supplemental housing modules into the plurality of recesses of the primary speaker housing, and rotating the plurality of protrusions of the first supplemental housing into the plurality of locking channels.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of a variable-sized speaker system, in accordance with an embodiment of the present disclosure;

FIG. 2 is a perspective view of a variable-sized speaker, in accordance with an embodiment of the present disclosure;

FIG. 3 is a perspective view of a primary speaker housing, in accordance with an embodiment of the present disclosure;

FIG. 4 is a perspective view of a supplemental housing module, in accordance with an embodiment of the present disclosure; and

FIG. 5 is a perspective view of a supplemental housing module, in accordance with an embodiment of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The system and methods disclosed herein relate generally to a variable-sized speaker system (e.g., speaker system, audio system, loudspeaker, soundbar, subwoofer, satellite speaker) formed from housing modules (e.g., housing pieces, housing portions, housing parts), where different modules can be employed to adjust the size of an enclosure and corresponding cavity (also referred to as a sound cavity) of the variable-sized speaker system. The housing modules may include a primary speaker housing, one or more supplemental housing modules, a back plate, and so forth. The primary speaker housing may be defined as a base portion with an inner radial wall defining a sound cavity that holds a speaker. The speaker may essentially block off one end of the sound cavity of the primary speaker housing and the other end of the sound cavity may form an access port, which may allow for extension of the enclosure and a corresponding extension of the sound cavity that the enclosure defines. This may facilitate ready access to adjustment of speaker system performance characteristics and improve associated efficiency of system maintenance, installation, and so forth. For example, adjustments to a speaker system (e.g., increasing a size (e.g., volume) of a sound cavity) can be made without requiring ordering of new parts or extended maintenance time to swap out speaker systems.

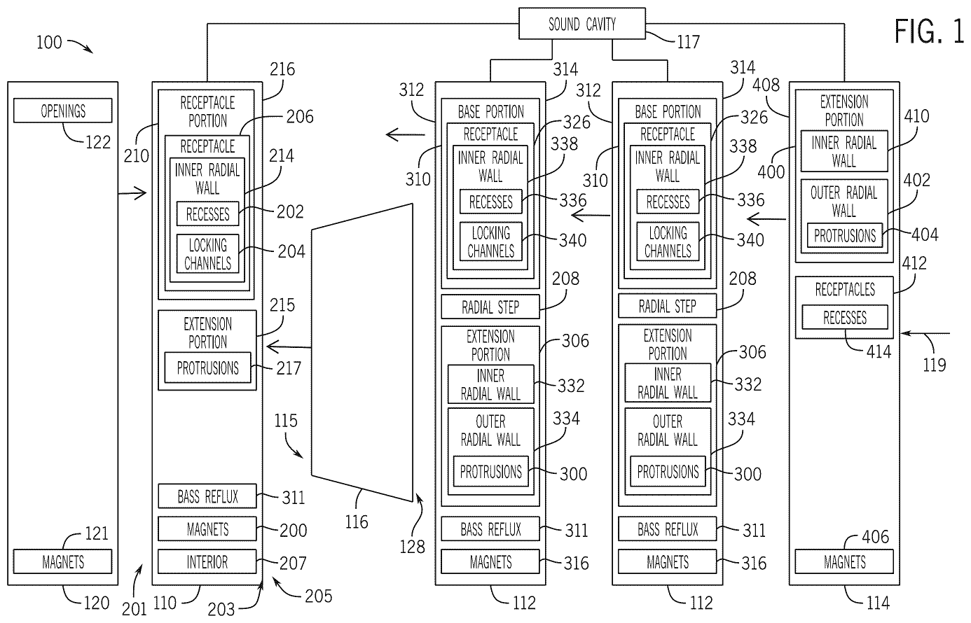

With reference to FIGS. 1-5, the housing modules 110, 112, 114 (e.g., primary speaker housing 110, supplemental housing module 112, back plate 114) may include a receptacle 206, 326, 412 (e.g., a female connection portion) and/or an extension portion 215, 306, 400 (e.g., a male connection portion) to facilitate coupling of the housing modules 110, 112, 114. Via the extension portion 215, 306 or receptacle 206, 326, a primary speaker housing 110 may detachably couple to a supplemental housing module 112, which may detachably couple to another supplemental housing module 112, and so on, until a desired sound cavity 117 size (e.g., volume) and/or sound is achieved. A back plate 114 can then be detachably coupled to an outermost supplemental housing module 112 or the primary speaker housing 110 to block the opening of the enclosure 113 opposite the speaker 116. In some embodiments, the enclosure 113 may be left open at the back and no back plate 114 may be utilized (e.g., to achieve a desired sound characteristic). Different enclosure 113 and sound cavity 117 sizes may be desired to achieve certain audio characteristics and/or to accommodate other physical requirements or limitations for the variable-sized speaker system 100. For example, it will be appreciated that by adding or subtracting housing modules 112 and/or the back plate 114, and thereby changing the size (e.g., volume) of the sound cavity 117, a sound parameter (e.g., volume, quality, tonality) from the speaker 116 may be changed (e.g., amplified, diminished, increased, decreased).

In embodiments in which the primary speaker housing 110 includes a receptacle 206, the receptacle 206 may be operable to receive an extension portion 306 of a supplemental housing module 112 or an extension portion 400 of a back plate 114 which can be rotated within the receptacle 206 to secure the primary speaker housing 110 to the supplemental housing module 112 or back plate 114. In embodiments in which the primary speaker housing 110 includes an extension portion 215, the extension portion 215 of the primary speaker housing 110 may include a cylindrical shape that is formed about and partially defines the access port. That is, the extension portion 215 may at least partially define a portion of the sound cavity 117 (e.g. resonance chamber of the variable-sized speaker system 100). Similarly, supplemental housing modules 112 and back plate 114 may include corresponding receptacles 326, 412 and/or extension portions 306, 400 that may coordinate to allow for adjustable sizing of the variable-sized speaker system 100. In an embodiment, a supplemental housing module 112 may include an extension portion 306 on one side and a receptacle 326 on the other. However, some embodiments also include supplemental housing modules 112 with extension portions 306 on both sides or receptacles 326 on both sides.

More specifically, with respect to embodiments of the primary speaker housing 110 including the receptacle 206, the inner radial wall 214 that defines the receptacle 206 may comprise recesses 202 (e.g., holes, channels) including a cavity geometry operable to receive protrusions 300, 404 (e.g., fasteners, connectors) of an extension portion 306, 400 of a supplemental housing module 112 or back plate 144 in a receiving orientation. Through insertion of the extension portion 306, 400 into the receptacle 206, and further axial rotation of the protrusions 300, 404, the supplemental housing module 112, or back plate 114, may be detachably coupled to the primary speaker housing 110 in a secured (e.g., friction fit and interlocking) manner. Similarly, the primary speaker housing 110 may include the extension portion 215 with protrusions 217 that interlock with recesses 336 in the receptacle 326 of the supplemental housing module 112 or back plate 114. The addition of a supplemental housing module 112 to a variable-sized speaker system 100 may increase the sound cavity 117 size (e.g., volume, length) of the variable-sized speaker system 100. Likewise, the removal of a supplemental housing module 112 from a variable-sized speaker system 100 may do the opposite. The increase or decrease of the sound cavity 117 size of the variable-sized speaker system 100 may increase or decrease the volume and/or another audio parameter (e.g., tonality, quality) of the speaker 116.

Supplemental housing modules 112 and/or the back plate 114 in accordance with present embodiments may also include recesses 336, 414 within respective receptacles 326, 412 that may include a cavity geometry operable to receive protrusions 300, 217 attached to an extension portion 306, 215 of a separate supplemental housing module 112 or the primary speaker housing 110 to facilitate interlocking engagement. For example, through the insertion of an extension portion 306 (e.g., of a second supplemental housing module 112) into a receptacle 326 (e.g., of a first supplemental housing module 112) and rotation of the corresponding protrusions 300 (e.g., of a second supplemental housing module) of the extension portion 306 while inserted in the recesses 336 of the receptacle 326, the second supplemental housing module 112 may be coupled to the first supplemental housing module 112. The addition of the second supplemental housing module 112 to the first supplemental housing module 112 may further increase the sound cavity 117 size (e.g., volume, length) of the variable-sized speaker system 100. The increase (or decrease) of the sound cavity 117 size may increase (or decrease) a sound parameter (e.g., volume, quality, tonality) of the variable-sized speaker system 100. Housing modules 110, 112, 114 may be added in any amount to obtain a desired sound from the variable-sized speaker system 100.

The housing modules (e.g., the primary speaker housing 110, supplemental housing modules 112, and/or back plate 114) may include magnets 200, 316, 406, fixed in and/or on their respective bodies in positions configured to facilitate magnetically coupling the housing modules 110, 112, 114 together in engaged configurations. For example, a primary speaker housing 110 may have one or more magnets 200 disposed in and/or on a face of the primary speaker housing 110 that is configured to engage (e.g., magnetically engage) with the supplemental housing module 112 or back plate 114. For example, the supplemental housing module 112 and/or the back plate 114 may likewise have one or more magnets 316, 406 disposed in and/or on a first face 312, a back wall face 408 (e.g., an extension side face), a second face 314 (e.g., a receptacle side face), or both of the supplemental housing module 112 and/or back plate 114. The magnets 200, 316, 406 may be arranged to attract one another. That is, the poles of the magnets 200 of the primary speaker housing 110 may be opposite those of the supplemental housing module 112 (or back plate 114). As the primary speaker housing 110 and the supplemental housing module 112 (or back plate 114) approach each other (e.g., abut, touch) the magnets 200, 316, 406 of the primary speaker housing 110 and the supplemental housing module 112 (or back plate 114) may magnetically couple. In this way, the magnets 200, 316, 406 may prevent the housing module 110, 112, 114 from becoming inadvertently detached from the variable-sized speaker system 100 due to, for example, vibration. In an embodiment, the magnets 200, 316, 406 may abut (e.g., directly abut) the housing modules 110, 112, 114, and/or another respective magnet from the magnets 200, 316, 406 in a coupled configuration. In an embodiment, the magnets 200, 316, 406 may not directly abut the housing modules 110, 112, 114, and/or another respective from the magnets 200, 316, 406 in a coupled configuration. That is, the magnets 200, 316, 406 may be embedded within a respective housing module 110, 112, 114, and configured to magnetically interact or engage with another respective magnet of the magnets 200, 316, 406 without abutting (e.g. directly abutting). The magnets 200, 316, 406 may coordinate with other coupling mechanisms (e.g., rotational interlocking) to facilitate securement. For example, interlocking engagement of an extension portion 215, 306, 400 and a receptacle 206, 326, 412 may be partially maintained by coupled magnets 200, 316, 406 that resist rotation out of engagement. Further, it should be noted that arrangement of the magnets 200, 316, 406 (e.g., alignment of the magnetic poles) may facilitate coupling of any of various housing modules 110, 112, 114 in proper alignment. For example, the magnets 200, 316, 406 may be arranged so that two supplemental housing modules 112 can be detachably coupled together in proper alignment with each other.

FIG. 1 portrays a schematic view of a variable-sized speaker system 100 including a speaker guard 120, primary speaker housing 110, a speaker 116, multiple supplemental housing modules 112 and a back plate 114. The variable-sized speaker system 100 (e.g., audio loudspeaker system, loudspeaker system) may be assembled by linking together housing modules 110, 112, 114 (e.g., housing pieces, housing portions, sound chamber portions) to adjust the size of a sound cavity 117. The variable-sized speaker system 100 may include a speaker guard 120 comprising openings 122 to allow sound waves emanating from the front 115 of the speaker 116 to leave the variable-sized speaker system 100. The speaker guard 120 may also include magnets 121 configured to couple with magnets 200 of the primary speaker housing 110, which may allow for ease of access to speaker 116 at least partially nested in the interior 207 of the primary speaker housing 110.

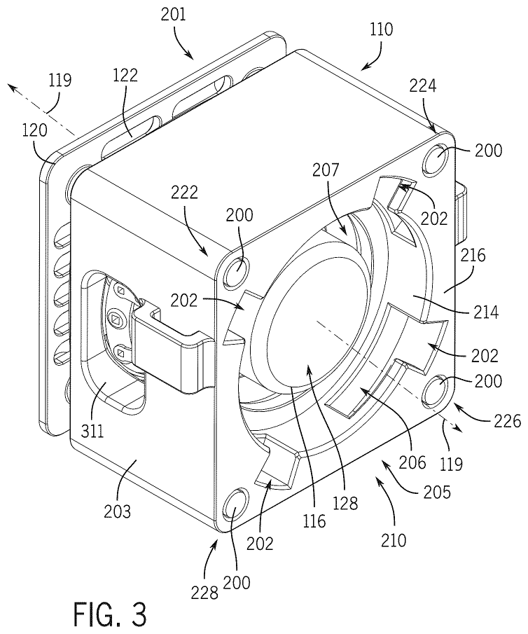

The primary speaker housing 110 may also include a receptacle portion 210, defining a receptacle 206, configured to receive an extension portion 306, 400 from a supplemental housing module 112 or a back plate 114. Further, the receptacle 206 may include or define an inner radial wall 214, defining recesses 202 and locking channel(s) 204 (e.g., cavity) extending traverse to an axis 119 extending through the variable-sized speaker system 100, as shown in FIG. 3. The recesses 202 and locking channels 204 may include a cavity geometry configured to receive protrusions 300, 404, extending radially from the outer radial wall 334, 402 of the supplemental housing module 112 or the back plate 114. For example, recesses 202 may receive protrusions 300 from a supplemental housing module 112, and upon radial movement of the supplemental housing module 112 while the protrusions 300 are inserted into the recesses 202, the protrusions 300 may be further twisted into the locking channels 204, enabling an engaged configuration between the primary speaker housing 110 and the supplemental housing module 112. The primary speaker housing 110 may also comprise magnets 200, disposed in or on a receptacle face 216, configured to magnetically couple with similarly positioned magnets 316, 406 on a face (e.g., first face 312, back wall face 408) of the supplemental housing module 112 or the back plate 114.

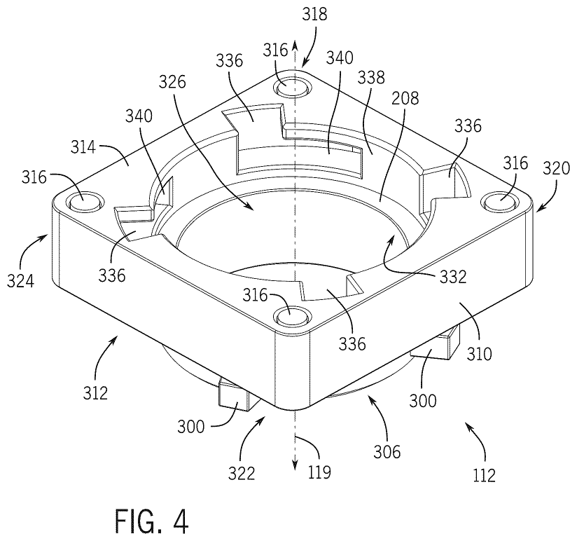

Further, the supplemental housing modules 112 may include a base portion 310, similar to the receptacle portion 210 of the primary speaker housing 110. The base portion 310 may define a receptacle 326, configured to receive an extension portion 306, 400 from another supplemental housing module 112 or a back plate 114. In an embodiment, the primary speaker housing 110 comprises an extension portion 215 and radially extending protrusions 217, configured to couple with a receptacle 326, 412 of a supplemental housing module 112 or back plate 114. The receptacle 326 of a supplemental housing module 112 may include or define an inner radial wall 338, defining recesses 336 and locking channels 340 (e.g., cavities) extending traverse to an axis 119 extending through the variable-sized speaker system 100, as shown in FIG. 4. The recesses 336 and locking channels 340 may include a cavity geometry configured to receive protrusions 300, 404, extending radially from the outer radial wall 334, 402 of a second supplemental housing module 112 or the back plate 114. For example, recesses 336 may receive protrusions 300 from a second supplemental housing module 112 (e.g., receiving orientation), and upon radial movement of the second supplemental housing module 112, while the protrusions 300 are inserted into the recesses 336, the protrusions 300 are further twisted into the locking channels 340, enabling an engaged configuration (e.g., engaged orientation) between a first supplemental housing module 112 and a second supplemental housing module 112.

The supplemental housing module 112 may also comprise magnets 316, disposed in or on a first face 312 and/or a second face 314 configured to magnetically couple with similarly positioned magnets 200, 406 on a face (e.g., receptacle face 216, back wall face 408) of the primary speaker housing 110 or the back plate 114.

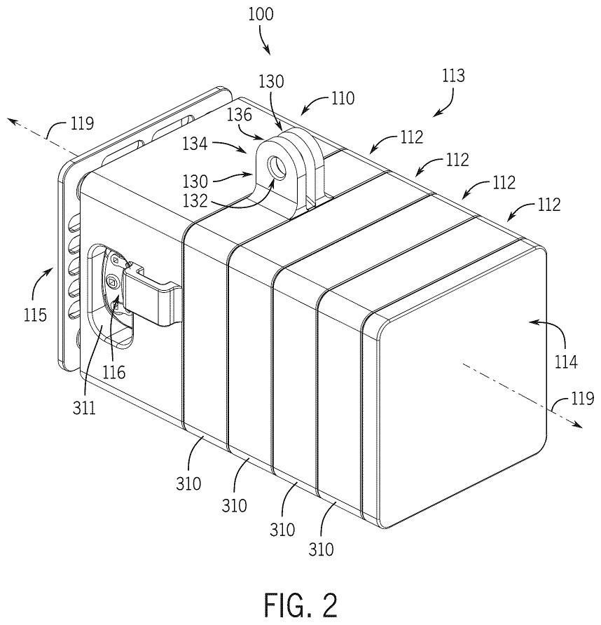

Turning now to FIG. 2, a perspective view of a variable-sized speaker system 100 with a primary speaker housing 110 and a plurality of supplemental housing modules 112 is portrayed. As illustrated, the variable-sized speaker system 100 may include multiple supplemental housing modules 112, wherein each supplemental housing module 112 added to the variable-sized speaker system 100 may increase the size (e.g., volume) of the sound cavity 117 (shown in FIG. 1) extending throughout an enclosure 113 defined by the variable-sized speaker system 100. It will be appreciated that increasing the volume of the sound cavity 117 by adding supplemental housing modules 112 may alter an acoustic output (e.g., increase the bass response, tonality, volume, quality) of the variable-sized speaker system 100.

The supplemental housing modules 112 defining the sound cavity 117 may block sound waves emanating from a rear 128 (shown in FIG. 1) of the speaker 116 from interfering (e.g., interfering destructively) with sounds waves emanating from the front 115 of the speaker 116. For example, sound waves originating or emanating from the rear 128 of the speaker 116 may be out of phase (e.g., desynchronized, disharmonious, mismatched) with the sound waves originating from the front 115 of the speaker 116, which may result in degradation of the quality and/or the sound level of the sounds waves emanating from the front 115 of the speaker 116. Therefore, without a sound cavity 117 defined by the housing modules 112 preventing such interference, the speaker 116 may produce undesirable sound characteristics.

The interior of the housing modules 110, 112, 114 of the variable-sized speaker system 100 may include absorptive materials (e.g., glass wool, wool, synthetic fibers) to aid in reducing sound waves originating from the rear 128 of the speaker 116 from interfering (e.g., destructively interfering) with the sound waves originating from the front 115 of the speaker 116. For example, each supplemental housing module 112 and the primary speaker housing 110 of the variable-sized speaker system 100 may include absorptive materials attached to (e.g., coupled via fasteners, friction fit, glued) to an extension portion inner radial wall 332, 410 of the housing module 112, 114. In this way, as the supplemental housing module 112 and/or the back plate 114 comprising an extension portion inner radial wall 332, 410 defining a portion of the sound cavity 117, are added to the primary speaker housing 110, the sound cavity 117 may be customized for desired sound characteristics, as generally illustrated in FIGS. 1 and 2. Further, a back plate 114 with insulating material on an interior facing side may be added to close off an end of the enclosure 113. For example, in an embodiment, an enclosure 113 and corresponding cavity that is fully insulated (e.g., covered) with absorptive materials may be assembled with the housing modules 110, 112, 114.

In an embodiment, an extension portion inner radial wall 332, 410 may be textured to increase the surface area of the sound cavity 117. For example, the extension portion inner radial wall 332, 410 may include divots and/or protrusions (e.g., three dimensional shaped protrusions) that increase the surface area of the extension portion inner radial wall 332, 410 and therefore increase the surface area of the sound cavity 117. In this way, a parameter of sound (e.g., volume, quality, tonality) may further be altered. Texturing, contours, obstacles, and so forth may be added via attachments (e.g., shapes configured to couple to the extension portion inner radial wall 332, 410) or deformation of a boundary (e.g., extension portion inner radial wall 332, 410).

In an embodiment, the sound cavity 117 of the variable-sized speaker system 100 may act to alter the sound waves originating from the rear 128 (illustrated in FIGS. 1 and 3) of the speaker 116 to constructively interfere with the sounds waves originating from the front 115 of the speaker 116. For example, one or more supplemental housing module 112 may include a bass reflux 311 (e.g., reflex port, vented box, hole) fluidly connecting the sound cavity 117 to the outside of the variable-sized speaker system 100. In other embodiments, the primary speaker housing 110 may also include a bass reflux 311 in conjunction with the bass reflux 311 of the one or more supplemental housing modules 112 or in place thereof. In an embodiment, the bass reflux 311 may face the same direction as the front 115 of the speaker 116, wherein the sound waves originating from the rear 128 of the speaker 116 and exiting the bass reflux 311 are substantially in the same direction as the sound waves originating from the front 115 of the speaker 116. In this way, sound waves originating from the rear 128 of the speaker 116 and exiting through the bass reflux 311 may constructively interfere with the sound waves originating from the front 115 of the speaker 116 thereby altering the acoustics of the variable-sized speaker system 100.

The primary speaker housing 110 may also include a coupler 134, configured to detachably couple the variable-sized speaker system 100 to a desirable location. For example, the variable-sized speaker system 100 may be detachably coupled, via the coupler 134, to components of an entertainment venue (e.g., on a wall, floor, or ceiling), to an animated figure (e.g., a robotic humanoid or animal), to a theme park ride (e.g., a ride vehicle), or any other suitable location. The coupler 134 may comprise at least one attachment protrusion 130 configured to facilitate attachment. For example, in the illustrated embodiment, there are two attachment protrusions 130 that are each configured to receive a fastener (e.g., a cable, pin, peg, nail, screw) in receptacles 132 (e.g., holes). Further, in the illustrated embodiment, the two attachment protrusions 130 are spaced apart to define a crevice 136, which is configured to receive a separate fastening protrusion (not shown) of a feature (not shown). Accordingly, the separate fastening protrusion may be inserted into the crevice 136 and a fastener may be passed through the separate fastener protrusion and the receptacles 132 of the two attachment protrusions 130 of the coupler 134 to secure the variable-sized speaker system 100 to the feature. In an embodiment, different numbers of attachment protrusions 130 may be included and additional crevices 136 formed to receive addition separate fastener protrusions. The receptacles 132 may be configured to receive any manner of fastener (e.g., a screw) in order to detachably couple (e.g., fasten) the separate fastener protrusion between the attachment protrusions 130. In this way, the variable-sized speaker system 100 may be detachably coupled to a fastening location. Further, the coupler 134 in conjunction with the separate fastening protrusion and fastener may be configured to allow rotation of the variable-sized speaker system 100 with respect to a pivot along a fastener axis (e.g., an axis defined by a central line through the length of the fastener). The coupler 134 is not limited to a position on the primary speaker housing 110, and may be on any housing module suitable and/or desirable (e.g., supplemental housing module 112, back plate 114).

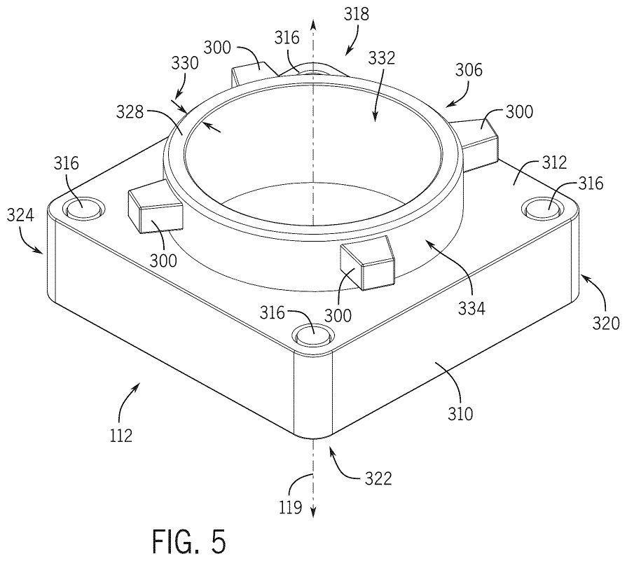

The variable-sized speaker system 100 may further include the back plate 114, which is configured to detachably coupled to a supplemental housing module 112 (e.g., the last housing module added, the outermost housing module) and/or the primary speaker housing 110. The back plate 114 may be configured to close (e.g., seal) the sound cavity 117 defined by the housing modules 110, 112, 114. In this way, acoustic waves produced inside (e.g., inside the sound cavity 117) the variable-sized speaker system 100 may be blocked from leaking out of the variable-sized speaker system 100, thereby changing (e.g., increasing, decreasing) a parameter of sound produced by the speaker 116 (e.g., volume, amplitude, frequency, quality, tonality). The back plate 114 may detachably couple to the primary speaker housing 110 and/or an outer-most one of the supplemental housing modules 112 by any suitable means (e.g., mechanically, magnetically). For example, the back plate 114 may include magnets 406, similar to those disposed on and/or in the primary speaker housing 110 and/or the supplemental housing modules 112. The magnets 406 of the back plate 114 may be attracted (e.g., magnetically attracted) to magnets 200, 316 and/or metal disposed on and/or in the supplemental housing module 112 or the primary speaker housing 110. Furthermore, the back plate 114 may comprise an extension portion 400 (illustrated in FIG. 1) configured to be inserted into the primary speaker housing 110 or one of the supplemental housing modules 112. The extension portion 400 of the back plate 114 may be similar to the shape and design of the extension portion 306 (as shown in FIG. 5) of the supplemental housing modules 112 as described below. That is, the extension portion 400 of the back plate 114 may be circular in shape defining an outer radial wall 402. The outer radial wall 402 may have protrusions 404 radially extending therefrom, configured to be inserted into recesses 202, 336 of the supplemental housing modules 112 and/or the primary speaker housing 110 (as shown in FIG. 5). In this way, the addition of the back plate 114 may close off the sound cavity 117 of the variable-sized speaker system 100 at an end. As with the other housing modules 110, 112, 114, the back plate 114 may be made of any suitable material, including lossy wall material, metal, polymer, plastic, or composites.

FIG. 3 is a perspective view of a primary speaker housing 110 for the variable-sized speaker system 100, in accordance with an embodiment of the present disclosure. The primary speaker housing 110 may be configured to enclose (e.g., cover, encapsulate) at least a portion of the speaker 116. For example, the primary speaker housing 110 may comprise a front end 201, a back end 205, and side walls 203. The interior 207 of the primary speaker housing 110 and exterior of the speaker 116 may be cooperatively shaped to facilitate a nested engagement of the speaker 116 within the primary speaker housing 110. For example, the primary speaker housing interior 207 may have a cylindrical shape, similar in size and shape to a body of the speaker 116. In this way, the speaker 116 may be inserted into the primary speaker housing 110 and secured therein. While a friction fit may be sufficient, in an embodiment, the primary speaker housing 110 and the speaker 116 may be additionally or alternatively secured by other fastening features (e.g., receptacles and fasteners) for maintaining positioning of the speaker 116 inside the primary speaker housing 110.

A speaker guard 120 may be detachably coupled to the face (e.g., front end 201) of the primary speaker housing 110 in order to protect the speaker 116 from damage (e.g., fall damage, debris damage). Further, the speaker guard 120 may include openings 122 (e.g., slits, holes) configured to allow sound waves originating from the front 115 of the speaker 116 to pass through the speaker guard 120, while still maintaining protection for the speaker 116. The speaker guard 120 may include any number and shape of openings 122 desirable in order to provide protection for the speaker 116 while allowing sound waves to pass through. Further, the speaker guard 120 may be coupled (e.g., attached) to the primary speaker housing 110 via any suitable mechanism for attachment. For example, and in an embodiment, the speaker guard 120 may be magnetically coupled to the primary speaker housing 110 via magnets 121 (as shown in FIG. 1). In this way, the speaker guard 120 may be replaced without tools and in an expedited matter. In embodiments using magnets 121 as the means for coupling the speaker guard 120 to the primary speaker housing 110, the speaker 116 may be easily removed through the front of the primary speaker housing 110 without tools and in an expedited matter. Similarly, the speaker guard 120 may be coupled via threaded connections into the primary speaker housing 110 in a way that allows for coupling or removal without tools and such a coupling may be supplemented by magnets 121, like the connections described above with respect to the housing modules 110, 112, 114.

The primary speaker housing 110 may include a receptacle portion 210 (e.g., back of the primary speaker housing 110) defining a receptacle 206 configured to receive an extension portion 306, 400 (as shown in FIG. 1) from a supplemental housing module 112 or back plate 114. In the illustrated embodiment, the receptacle 206 is circular in shape, and includes a diameter larger (e.g., wider) than that of the diameter of the extension portion 306, 400 (e.g., an extension portion 306, 400 to be inserted). In this way, the extension portion 306, 400 may be inserted into the receptacle 206. Further, the receptacle portion 210 of the primary speaker housing 110 may define recesses 202 (e.g., holes), extending through a receptacle face 216 of the receptacle portion 210, configured to receive protrusions 300, 404 from the supplemental housing module 112 or the back plate 114 in a receiving orientation, as shown in FIG. 1. The recesses 202 may have any shape suitable to receive the protrusions 300, 404 from the supplemental housing module 112 or the back plate 114. For example, in the illustrated embodiment, the receptacle portion 210 defines recesses 202 with a dove tail shape (e.g., side walls tapering inward toward each other). Indeed, the recess 202 shape and/or size may be one that facilitates the attachment (e.g., coupling, connection) of the supplemental housing module 112 or the back plate 114 to the primary speaker housing 110 via insertion of the protrusions 300, 404 into the recesses 202. For instance, a dovetail shaped recess 202 may include a size (e.g., width) substantially larger than the size (e.g., width) of the protrusion 300. In this way, insertion of the protrusions 300, 404 into the recesses 202 may be easier, thereby expediting the modification process of a variable-sized speaker system 100.

In the illustrated embodiment, the primary speaker housing 110 includes four recesses 202, however, it should be noted that any number of the recesses 202 (e.g., 1, 2, 3, 5, 6, 7, 8) may be used in accordance with the present disclosure. Further, the recesses 202 may be located at various locations (e.g., orientations) around the circumference of the receptacle 206 of the receptacle portion 210. It will be appreciated that the orientation of the recesses 202 may vary, and the disclosure covers all possible locations/orientations of the recesses 202 on and/or in the receptacle portion 210. For example, the recesses 202 may be oriented in an offset matter around the receptacle 206 with respect to a desired coupled configuration of a supplemental housing module 112 and the primary speaker housing 110 or back plate 114. For example, the recesses 202 of the illustrated embodiment may be oriented slightly counterclockwise relative to respective corners 222, 224, 226, 228 of the primary speaker housing 110, while a corresponding plurality of protrusions 300 of a supplemental housing module 112 being coupled may be aligned with respective corners of the supplemental housing module 112. In this way, upon insertion of the plurality of protrusions 300 of the supplemental housing module 112 into the plurality of recesses 202 of the primary speaker housing 110, the supplemental housing module 112 will be slightly offset (e.g., staggered, sides not flush) relative to the primary speaker housing 110. However, upon axial clockwise rotation of the supplemental housing module 112 relative to the primary speaker housing 110, which drives the plurality of protrusions 300 into locking channels 204 (e.g., slots or grooves) of the recesses 202 (and into secured engagement), the housing module 112, 114 may be centered (e.g., aligned, flush) with the primary speaker housing 110.

In the illustrated embodiment, the receptacle portion 210 has an inner radial wall 214 defining the receptacle 206. The inner radial wall 214 includes the locking channels 204 (e.g., cavities), wherein the locking channels 204 are extensions of the recess 202 in a direction along (e.g., clockwise or counter-clockwise) the inner radial wall 214 and extending traverse to an axis 119 extending through the variable-sized speaker system 100. A primary speaker housing 110 comprising a plurality of recesses 202 may receive an extension portion 306 of a supplemental housing module 112 comprising a plurality protrusions 300 radially extending from the extension portion 306, and upon axial rotation of the of the supplemental housing module 112 while the protrusions 300 are inserted into the recesses 202, the protrusions 300 may further be inserted into (e.g., twisted into) the locking channels 204 of the recesses 202 in an engaging orientation. In this way, the supplemental housing module 112 may be “locked” (e.g., coupled) in an engaging orientation to the primary speaker housing 110, blocking direct axial extraction of the supplemental housing module 112 from the primary speaker housing 110. For example, a primary speaker housing 110 comprising an inner radial wall 214 of the receptacle portion 210 may include locking channels 204 that extend clockwise of the recesses 202. Upon clockwise axial rotation of the supplemental housing module 112 while the protrusions 300 are inserted into the recesses 202, the protrusions 300 may further be inserted into (e.g., slid into, twisted into) the locking channels 204 extending clockwise from the recesses 202 in an engaging orientation. The locking channels 204 may narrow as they extend such that as the protrusions 300 more fully engaged with the locking channels 204, a tighter friction fit is generated. Thus, a secure engagement may be achieved. Further, as discussed above, supplemental magnets (e.g., the magnets 200, 316) may operate to resist transition out of this engagement.

In the illustrated embodiment, the locking channels 204 do not extend through the receptacle face 216 of the receptacle portion 210. A protrusion 300 may enter the recess 202 of the receptacle portion 210, the protrusion 300 may then axially rotate into the locking channel 204 (e.g., upon twisting), where the protrusion 300 is then blocked, by the receptacle face 216 of the receptacle portion 210, from translating in a longitudinal direction (e.g., horizontal) away from the primary speaker housing 110. In this way, the protrusion 300 in the locking channel 204 may couple (e.g., attach) the primary speaker housing 110 to the supplemental housing module 112 of the back plate 114 in an engaged configuration.

The receptacle portion 210 of the primary speaker housing 110 may include magnets 200 to enable and/or supplement coupling between the supplemental housing module 112 of the back plate 114. While the magnets 200 may be positioned in various locations in accordance with embodiments of the present disclosure, in the illustrated embodiment of FIG. 3, the magnets 200 are disposed in and/or on the receptacle face 216 of the receptacle portion 210. The magnets 200 may be configured to magnetically couple the receptacle portion 210 of the primary speaker housing 110 to a supplemental housing module 112 and/or back plate 114 in a coupled configuration. For example, the primary speaker housing 110 may have magnets 200 disposed in the receptacle face 216 (e.g., a magnet disposed in each corner) of the receptacle portion 210. Similarly, as illustrated in FIG. 5, a supplemental housing module 112 may have magnets 316 and/or metal capable of magnetic attraction disposed on a first face 312 (e.g., extension side face) of a base portion 310 and configured to align with the magnets 200 of the primary speaker housing 110. In this way, as the primary speaker housing 110 (as illustrated in FIG. 3) becomes more proximate to the supplemental housing module 112 (as illustrated in FIGS. 4 and 5), the respective magnets 200, 316 (and/or metal) of both the primary speaker housing 110 and the supplemental housing module 112 may magnetically attract to make a magnetic connection. Therefore, the supplemental housing module 112 and the primary speaker housing 110 may be coupled (e.g., magnetically coupled) and/or decoupled (e.g., magnetically decoupled) without the need of tools.

The magnets 200 may be disposed at any location on the primary speaker housing 110 desirable and/or suitable to couple the primary speaker housing 110 to the supplemental housing module 112 or the back plate 114. For example, in the illustrated embodiment, magnets 200 are disposed in the receptacle face 216 in each of four corners 222, 224, 226, 228 of the primary speaker housing 110. Further as shown in FIG. 5, the supplemental housing module 112 may similarly have magnets 316 disposed in a first face 312 of the base portion 310 of the supplemental housing module 112 at four corners 318, 320, 322, 324. In this way, as the illustrated primary speaker housing 110 and the supplemental housing module 112 are coupled together, the magnets 200, 316 may provide coupling at multiple locations, which may result in increased retention of the supplemental housing module 112 on the primary speaker housing 110. It should be noted that magnets 200 may be paired with magnetic metal instead of aligning magnets that attract. For example, the magnets 200 may be replaced with metal that is attracted to the magnets 316.

The primary speaker housing 110 may comprise both the recesses 202 configured to receive protrusions 300 radially extending from an extension portion 306 of a supplemental housing module 112 (or a back plate 114), and the magnets 200 disposed in and/or on the primary speaker housing 110 (e.g., in or on the receptacle face 216). For example, the receptacle portion 210 of the primary speaker housing 110 may receive an extension portion 306 of a supplemental housing module 112 with radially extending protrusions 300. Upon locking the protrusions 300 into the locking channels 204, in a manner similar to that described above, the magnets 200 of the primary speaker housing 110 and the magnets 316 of the supplemental housing module 112 may also be aligned, and therefore may create a magnetic coupling, in addition to the mechanical coupling from the insertion of the protrusions 300 into the recesses 202. This creates a supplemental magnetic engagement that supports the locking of the protrusions 300 into the locking channels 204 and aids in preventing the inadvertent rotation of the protrusions 300 out of the locking channels 204.

FIGS. 4 and 5 are perspective views of a supplemental housing module 112 of the variable-sized speaker system 100. FIG. 4 is a perspective view of the supplemental housing module 112 with the receptacle 326 facing upwards. FIG. 5 is a perspective view of the supplemental housing module 112 with the extension portion 306 facing upwards. Supplemental housing module 112 may include any size length, width, and/or height to achieve a desirable sound cavity 117 size and/or variable-sized speaker system 100 size. The receptacle 326 of the supplemental housing module 112 may be similar in shape and size to the receptacle 206 of the primary speaker housing 110 the supplemental housing module 112, and/or the back plate 114. This allows for ready coupling between any two housing modules 110, 112, 114. Further, the modularity provided by similarly shaped components allows a desired amount (e.g., 1, 2, 3, 4, 5, 6, etc.) of supplemental housing modules 112 (and/or back plate 114) to be coupled together and to the primary speaker housing 110 such that two dimensions (e.g., width and height) of a corresponding enclosure 113 are kept constant while a third dimension (e.g., length) is varied.

The supplemental housing module 112, as illustrated in FIGS. 4 and 5, may comprise the base portion 310 (e.g., receptacle portion) and an extension portion 306. The base portion 310 may define a receptacle 326, similar to the receptacle 206 of the primary speaker housing 110, which is configured to receive an extension portion 306, 400 from a second housing module (e.g., a second supplemental housing module 112, a back plate 114). The extension portion 306 may extend outward from the base portion 310 and may comprise an extension portion wall 328 with a thickness 330. For example, the thickness 330 may be the difference between the radius of a first circle defined by the inner radial wall 332 and a second circle defined by an outer radial wall 334 of the extension portion 306. It should be noted that an interior of the extension portion 306 may define a portion of the sound cavity 117 and may essentially integrate with the receptacle 326.

While present embodiments are not limited to such geometries, the extension portion 306 and the receptacle 326 of the supplemental housing module 112 may be complementarily cylindrical in shape. The receptacle 326 may have a diameter substantially equal to the diameter defined by the outer radial wall 334 of the extension portion 306 (e.g., extension portion 306 of a second housing module). Further, the supplemental housing module 112 may comprise a radial step 208, located between the receptacle 326 and the extension portion 306, wherein the radial step 208 narrows (e.g., constricts) the circumference of the receptacle 326 to the internal circumference of the extension portion 306. The radial step 208 may be substantially the same width as the thickness 330 of the extension portion wall 328. In this way, when the extension portion 306 of a second supplemental housing module 112 is inserted into the receptacle 326 of a first supplemental housing module 112, the inner radial wall 332 of the extension portion 306 of the first supplemental housing module 112 may be aligned with the inner radial wall 332 of the extension portion 306 of the second supplemental housing module 112. Therefore, the sound cavity 117, defined by each extension portion 306 of the respective supplemental housing module 112 may be continuous throughout the variable-sized speaker system 100

The base portion 310 of the supplemental housing module 112 may function similar to the receptacle portion 210 of the primary speaker housing 110 and/or other supplemental housing modules 112, as described above. For example, the base portion 310 (e.g., receiving end of the supplemental housing module 112) may define a receptacle 326 configured to receive an extension portion 306, 400 from a second supplemental housing module 112 (or a back plate 114). The receptacle 326 may be circular in shape, and includes a radius larger (e.g., wider) than that of the radius of the extension portion 306, 400 of the second supplemental housing module 112 or back plate 114. In this way, the extension portion 306, 400 may be inserted into the receptacle 326. Further, the base portion 310 of the supplemental housing modules 112 may define recesses 336 (e.g., holes), extending through a second face 314 (e.g., receiving side face, receptacle face) of the base portion 310, configured to receive protrusions 300, 404 from the second supplemental housing module 112 or back plate 114 in a receiving orientation. The recesses 336 may have any shape suitable to receive the protrusions 300, 404 from the second supplemental housing module 112 or back plate 114. For example, in the illustrated embodiment, the base portion 310 defines recesses 336 with a dove tail shape (e.g., side walls tapering inward toward each other). The recesses 336 may receive any shaped protrusions 300, 404 that may fit within the dove tail (e.g., inverse dove tail, rectangle). Indeed, the recess 336 shape and/or size may be one that facilitates the attachment (e.g., coupling, connection) of the second supplemental housing module 112, or back plate 114 to the first supplemental housing module 112 via insertion of the protrusions 300, 404 into the recesses 336. For instance, a dovetail shaped recess 336 may include a size (e.g., width) substantially larger than the size (e.g., width) of the protrusion 300, 404. In this way, insertion of the protrusions 300, 404 into the recesses 336 may be easier (e.g., may require less accuracy when inserting), thereby expediting the modification process (e.g., adding or subtracting supplemental housing modules 112) of a variable-sized speaker system 100.

Further, and similar to the recesses 202 of the primary speaker housing 110, a supplemental housing module 112 may include four recesses 336, however, it should be noted that any number (e.g., 1, 2, 3, 5, 6, 7, 8) of recesses 336 may be used. The number of recesses 336 may be based on or depend on the number of protrusions 300, 404 of the second supplemental housing module 112 or the back plate 114. Further, the recesses 336 may be located at various locations (e.g., orientations) around the circumference of the opening of the receptacle 326. It will be appreciated that the orientation of the recesses 336 may vary, and the disclosure covers all possible locations/orientations of the recesses 336 on and/or in the base portions 310. For example, the recesses 336 may be oriented in an offset matter relative to a desired coupled configuration of the first supplemental housing module 112 and the second supplemental housing module 112. For example, each recess 336 of the illustrated embodiment may be oriented slightly counterclockwise relative to a corner 318, 320, 322, 324 (e.g. corner most adjacent to the respective recess 336) of the first supplemental housing module 112. In this way, upon insertion of a plurality of protrusions 300 of the second supplemental housing module 112 into a plurality of recesses 336 of the first supplemental housing module 112, the second supplemental housing module 112 will be slightly offset (e.g., staggered, sides not flush) relative to the first supplemental housing module 112. However, upon axial clockwise rotation of the second supplemental housing module 112, the second supplemental housing module 112 may be centered with (e.g., set, flush, aligned) the first supplemental housing module 112.

The base portion 310 of the supplemental housing module 112 may further have an inner radial wall 338 defining the receptacle 326 in a similar arrangement to that described above for the primary speaker housing 110. The inner radial wall 338 may further comprise locking channels 340 (e.g., cavities), wherein the locking channels 340 extend from the recess 336 in a direction along (e.g., clockwise or counterclockwise) the inner radial wall 338, and extending traverse to an axis 119 extending through the variable-sized speaker system 100. A first supplemental housing module 112 comprising a plurality of recesses 336 may receive a second supplemental housing module 112 or back plate 114 comprising a plurality of protrusions 300, 404 radially extending from the extension portion 306, 400, and upon axial rotation of the of the second supplemental housing module 112 or back plate 114 (relative to the first supplemental housing module 112) while the protrusions 300, 404 are inserted into the recesses 336 of the first supplemental housing module 112, the protrusions 300, 404 may further be moved into (e.g., twisted into) the locking channels 340 adjacent to the recesses 336. In this way, the second supplemental housing module 112 or back plate 114 may be “locked” (e.g., coupled) in an engaging orientation to the first supplemental housing module 112, blocking direct axial extraction of the second supplemental housing module 112 or back plate 114 from the first supplemental housing module 112. In the illustrated embodiment, and as an example, a first supplemental housing module 112 comprises an inner radial wall 338 of the base portion 310 includes locking channels 340 that extend in a clockwise direction relative to the recesses 336. Upon clockwise axial rotation of the second supplemental housing module 112 while the protrusions 300 are inserted into the recesses 336 (e.g., receiving orientation), the protrusions 300 are further inserted into (e.g., twisted into) the locking channels 340 extending clockwise from the recesses 336 of the first supplemental housing module 112 (e.g., engaging orientation). In this way, the first supplemental housing module 112 may couple and detach from second supplemental housing module 112, without the use of tools. For example, a technician may use his hands alone (e.g., using grabbing and twisting motions) to couple and decouple the first and second supplemental housing modules 112, without using tools (e.g., plyers, screw driver, power tools, hammer, etc.)

The base portion 310 of the supplemental housing module 112 may further include magnets 316 disposed in and/or on a first face 312 and/or a second face 314 of the base portion 310, in an arrangement similar to that described with respect to the primary speaker housing 110. For example, the magnets 316 may be configured to magnetically couple the base portion 310 of the first supplemental housing module 112 to a base portion 310 a second supplemental housing module 112 or a back plate 114 in a coupled configuration. For example, a first supplemental housing module 112 may have magnets 316 disposed in or on the second face 314 (e.g., receptacle side face, receiving side face) of the base portion 310. A second supplemental housing module 112 may similarly have magnets 316 and/or metal capable of magnetic attraction, disposed in or on a first face 312 (e.g., extension side face, insertion side face) of the second supplemental housing module 112 base portion 310 and configured to align with the magnets 316 of the first supplemental housing module 112 to create a magnetic coupling. In this way, as the first supplemental housing module 112 (e.g., a second face 314 of the first supplemental housing module 112) approaches a second supplemental housing module 112 (e.g., a first face 312 of the second supplemental housing module 112), the respective magnets 316 and/or metal of both the first supplemental housing module 112 and the second supplemental housing module 112 may magnetically attract to make a magnetic connection forming a coupled configuration between the supplemental housing modules 112. Therefore, a second supplemental housing module 112 may be coupled (e.g., magnetically coupled) and/or decoupled (e.g., magnetically decoupled) to the variable-sized speaker system 100 without the need of tools (e.g., attachment mechanisms that require tools). As such, the sound cavity 117 of the variable-sized speaker system 100 may be altered in an efficient manner (e.g., time-efficient manner), without the space needed (e.g., space surrounding the variable-sized speaker system) to use tools (e.g., handheld tools, power tools). In this way, a technician may alter sound (via altering the sound cavity 117) of the variable-sized speaker system 100 while the variable-sized speaker system 100 is placed in a location with limited access.

Further, magnets 316 may be disposed at any location on the supplemental housing module 112 desirable and/or suitable to couple the supplemental housing module 112 to another supplemental housing module 112, the primary speaker housing 110, and/or the back plate 114. For example, in the illustrated embodiment, the magnets 316 are disposed in the second face 314 (e.g., receptacle face) in four corners 318, 320, 322, 324. Further as shown in FIG. 5., a second supplemental housing module 112 may similarly have magnets 316 disposed in a first face 312 (e.g., extension side face) at four corners 318, 320, 322, 324. In this way, as the illustrated first supplemental housing module 112 and the second supplemental housing module 112 are coupled together in a coupled configuration, the magnets 316 may provide coupling in all corners, which may result in increased retention of the first supplemental housing module 112 on the second supplemental housing module 112. In an embodiment, the magnets 316 used to detachably couple a first supplemental housing module 112 to a second supplemental housing module 112 may be the same magnets 316 (e.g., same continuous magnet) as used to detachably couple a second supplemental housing module 112 to a third supplemental housing module 112 or a back plate 114. For example, the magnets 316 may extend substantially through the supplemental housing module 112 base portion 310 so that a portion of the magnet 316 is at least partially exposed on either side of the supplemental housing module 112 base portion 310 (e.g., on the first face 312 and the second face 314). This continuous extension of the magnets 316 through the supplement housing module 112 may facilitate proper arrangement of magnetic poles to facilitate serial coupling of housing modules 110, 112, 114.

The supplemental housing modules 112 may comprise both the recesses 336 configured to receive protrusions 300 from a second supplemental housing module 112 (or back plate 114), and magnets 316 disposed in and/or on the second supplemental housing module 112 (e.g., in or on the first face 312). For example, the receptacle 326 of a first supplemental housing module 112 may receive an extension portion 306 with radially extending protrusions 300 of a second supplemental housing module 112. Upon locking the protrusions 300 into the locking channels 340, in a manner similar to that described above (e.g., insertion of the protrusions 300 into the recesses 336, followed by radial movement into a locking channel 340), the magnets 316 of the first supplemental housing module 112 and the second supplemental housing module 112 may also be aligned, and therefore may also create a magnetic coupling, in addition to the mechanical coupling from the insertion of the protrusions 300 into the recesses 336, and further the locking of the protrusions 300 into the locking channels 340. This creates a supplemental magnetic engagement that supports the locking of the protrusions 300 into the locking channels 340.

As noted herein, the system and methods disclosed herein relate generally to a variable-sized speaker system 100 (e.g., audio loudspeaker system, loudspeaker system) assembled by linking together housing modules 110, 112, 114 (e.g., housing pieces, housing portions, sound chamber portions) to adjust the size of a sound cavity 117 of the variable-sized speaker system 100. Different insulations types, materials, component geometries, and so forth may be used to adjust audio characteristics of the sound cavity 117. The supplemental housing modules 112, may comprise a base portion 310, defining a receptacle 326, and an extension portion 306 extending from the base portion 310. The extension portion 306 may be cylindrical in shape and may at least partially define a portion of the sound cavity 117 (e.g. resonance chamber) of the variable-sized speaker system 100. A primary speaker housing 110 may be coupled in series to any desired amount of supplemental housing modules 112 to increase the size (e.g., volume) of the sound cavity 117. It will be appreciated that by adding or subtracting supplemental housing modules 112, and thereby changing the size (e.g., volume) of the sound cavity 117, a sound parameter (e.g., volume, tonality, quality) emanating from the speaker 116 may be changed (e.g., increased or decreased). The ability to modify the variable-sized speaker system 100 in this way creates efficiencies of assembly, maintenance, and installation that are not available in traditional speaker systems.

The primary speaker housing 110, the supplemental housing module 112, and the back plate 114 may each include magnets 200, 316, 406. For example, a supplemental housing module 112 may have magnets 316 that extend through the base portion 310 at locations proximate to the corners 318, 320, 322, 324. The magnets 316 may be exposed on the first face 312 (e.g., extension portion face) and/or the second face 314 (e.g., the receptacle portion face). The magnets 316 may operate with other magnets (e.g., magnets 200, 406) or magnetic metal to secure various housing modules 110, 112, 114 without further securement mechanisms. However, the magnets 316, 406 may also be used with a mechanical locking mechanism, such as those described above. For example, a first supplemental housing module 112 may include a receptacle 326, and magnets 316 disposed in the second face 314 (e.g., receptacle portion face) of the base portion 310. A second supplemental housing module 112 may include an extension portion 306, and magnets 316 disposed in the first face 312 (e.g., extension portion face) of the base portion 310. Upon the insertion and further locking of the protrusions 300 of the second supplemental housing module 112 into the recesses 336 and locking channels 340 of the first supplemental housing module 112, the magnets 316 disposed in both faces 312, 314 of the first and second supplemental housing modules 112 may magnetically couple. The use of magnets 200, 316, 406 in this way for the variable-sized speaker system 100 further improves operational efficiencies, such as by creating ease of maintenance by limiting the need for tools.

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform) ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A speaker system for an entertainment venue, comprising:
a speaker;
a primary speaker housing configured to at least partially enclose the speaker; and
one or more of supplemental housing modules, wherein a first supplemental housing module of the one or more of supplemental housing modules is configured to detachably couple to the primary speaker housing, and is configured to define a first portion of a sound cavity for the speaker system, and wherein a second supplemental housing module of the one or more of supplemental housing modules is configured to detachably couple to the first supplemental housing module, and is configured to define a second portion of the sound cavity of the speaker system.

2. The speaker system of claim 1, wherein the first supplemental housing module comprises:
a first extension portion comprising a first plurality of protrusions radially extending therefrom; and
a first receptacle portion comprising a first plurality of recesses configured to receive a second plurality of protrusions.

3. The speaker system of claim 2, wherein the primary speaker housing comprises a second plurality of recesses configured to receive the first plurality of protrusions from the first supplemental housing module.

4. The speaker system of claim 2, wherein the second supplemental housing module comprises:
a second extension portion comprising a second plurality of protrusions radially extending therefrom; and
a second receptacle portion comprising a second plurality of recesses configured to receive a third plurality of protrusions.

5. The speaker system of claim 4, wherein the primary speaker housing, the first supplemental housing module, or both, comprise a plurality of magnets configured to establish magnetic engagement between the first supplemental housing module and the primary speaker housing.

6. The speaker system of claim 5, wherein:
the first plurality of recesses comprise a cavity geometry that allows axial rotation of the first plurality of protrusions while within the first plurality of recesses into an engaging orientation;
the primary speaker housing, the first supplemental housing module, or both comprise a plurality of magnets; and
the plurality of magnets is configured to establish magnetic engagement between the first supplemental housing module and the primary speaker housing in the engaging orientation.

7. The speaker system of claim 2, wherein the first plurality of recesses is configured to axially receive the first plurality of protrusions in a receiving orientation.

8. The speaker system of claim 7, wherein the first plurality of recesses comprise a cavity geometry that allows axial rotation of the first plurality of protrusions while within the first plurality of recesses into an engaging orientation.

9. The speaker system of claim 8, wherein the engaging orientation blocks direct axial extraction of the first plurality of protrusions from the first plurality of recesses.

10. The speaker system of claim 2, wherein the first supplemental housing module includes a first plurality of locking channels extending traverse to an axis of the speaker system and configured to receive the second plurality of protrusions after insertion into the first plurality of recesses.

11. A speaker enclosure, comprising:
a primary speaker housing configured to nest about a speaker;
a first supplemental housing module configured to detachably couple to the primary speaker housing, wherein the first supplemental housing module is configured to define a portion of a sound cavity for the speaker enclosure having an axis; and
a second supplemental housing module, configured to detachably couple to the first supplemental housing module, wherein the second supplemental housing module is configured to define a second portion of the sound cavity of the speaker enclosure.

12. The speaker enclosure of claim 11, wherein the second supplemental housing module is configured to define the second portion of the sound cavity of the speaker enclosure such that the sound cavity extends away from the speaker along the axis.

13. The speaker enclosure of claim 11, comprising:
a first plurality of magnets coupled to or integrated with the primary speaker housing; and
a second plurality of magnets coupled to or integrated with the first supplemental housing module, wherein the first plurality of magnets and the second plurality of magnets are configured to align and magnetically engage in a coupled configuration of the primary speaker housing and the first supplemental housing module.

14. The speaker enclosure of claim 13, wherein each magnet of the second plurality of magnets extends through the first supplemental housing module such that:
a first end of each magnet is configured to magnetically engage with the primary speaker housing in the coupled configuration of the primary speaker housing and the first supplemental housing module; and
a second end of each magnet is configured to magnetically engage the second supplemental housing module in a coupled configuration of the first supplemental housing module and the second supplemental housing module.

15. The speaker enclosure of claim 11, wherein the first supplemental housing module comprises:
a first extension portion comprising a first plurality of protrusions radially extending therefrom; and
a first receptacle portion comprising a first plurality of recesses configured to receive a second plurality of protrusions.

16. The speaker enclosure of claim 15, wherein the primary speaker housing comprises a second plurality of recesses configured to receive the first plurality of protrusions from the first supplemental housing module.

17. The speaker enclosure of claim 15, wherein the second supplemental housing module comprises:
a second extension portion comprising a second plurality of protrusions radially extending therefrom; and
a second receptacle portion comprising a second plurality of recesses configured to receive a third plurality of protrusions.

18. The speaker enclosure of claim 15, wherein:
the first plurality of recesses is configured to axially receive the first plurality of protrusions in a receiving orientation;
the first plurality of recesses comprises a cavity geometry that allows axial rotation of the first plurality of protrusions while within the first plurality of recesses into an engaging orientation; and
the engaging orientation blocks direct axial extraction of the first plurality of protrusions from the first plurality of recesses.

19. The speaker enclosure of claim 18, wherein the primary speaker housing, the first supplemental housing module, or both comprise a plurality of magnets configured to establish magnetic engagement between the first supplemental housing module and the primary speaker housing.

20. A method of modifying a speaker system, the method comprising:
inserting a speaker into a primary speaker housing configured to at least partially enclose the speaker, the primary speaker housing comprising a first plurality of recesses and a plurality of locking channels; and
detachably coupling one or more supplemental housing modules to the primary speaker housing until a desired sound is reached, comprising the steps of:
inserting a plurality of protrusions of a first supplemental housing module of the one or more supplemental housing modules into the plurality of recesses of the primary speaker housing; and
rotating the plurality of protrusions of the first supplemental housing module into the plurality of locking channels.
